(19) United States
(12) Patent Application Publication
(10) Pub. No.: US 2014/0349085 A1
(43) Pub. Date: Nov. 27, 2014

(54) METHOD OF FABRICATING 3D NANOSTRUCTURED METAL OXIDES USING PROXIMITY-FIELD NANOPATTERNING AND ATOMIC LAYER DEPOSITION

(71) Applicant: KOREA ADVANCED INSTITUTE OF SCIENCE AND TECHNOLOGY, Daejeon (KR)

(72) Inventors: SeokWoo Jeon, Daejeon (KR); ChangUi Ahn, Daejeon (KR)

(73) Assignee: KOREA ADVANCED INSTITUTE OF SCIENCE AND TECHNOLOGY, Daejeon (KR)

(21) Appl. No.: 14/097,971

(22) Filed: Dec. 5, 2013

(30) Foreign Application Priority Data
May 23, 2013 (KR) 10-2013-0058212

(51) Int. Cl. B29C 63/00

(52) U.S. Cl. CPC B29C 63/0017; B29C 2063/006
USPC 428/195.1; 264/46.4

(57) ABSTRACT

The present invention is 3D nanostructured porous metal oxide and the method of fabricating said metal oxide, wherein said method is comprising the steps of: (a) spin-coating with photoresist onto substrate; (b) forming periodic 3D porous nanostructure patterned pore in said photoresist using proximity-field nanopatterning; (c) impregnating metal oxide into said 3D pore of photoresist having said periodic 3D pore pattern as template via atomic layered deposition (ALD) with metal precursor; and (d) obtaining 3D nanostructured porous metal oxide having the inverse shape of said template by removing said photoresist template.

### BACKGROUND OF THE INVENTION

1. Field of the Invention

The present invention relates to 3D nanostructured metal oxides with large surface area and methods of fabricating the metal oxides, and efficient hydrogen-production materials using the metal oxides.

2. Description of the Related Art

Hydrogen is considered a new energy sources which can solve current energy problems due to its environmental-friendly nature and abundant raw material in water. However, currently developed hydrogen-production materials do not have enough competitiveness due to low efficiency. Still, the development of hydrogen production materials in high efficiency can bring the core solution to the future energy problems.

Hydrogen-production materials consist of metal oxides with high oxygen defects on the surface. Oxygen defects in the surface cause thermochemical breakdown of water, thus producing hydrogen. Since the production of hydrogen is taken place on the surface of metal oxides, it is important to increase the surface area of hydrogen-production materials for the high efficiency. To increase the surface area of metal oxides, several methods are suggested.

A method involves the synthesis of 1D nanostructured metal oxides in the form of nanowire or nanotube to increase the surface area. This method gives synthetic nanoparticles of metal oxides with various forms and high surface area, which could lead to the enhanced hydrogen production. However, the complexity of the process, low reproducibility, and low uniformity make it difficult to apply to the present hydrogen-producing materials.

Another method is producing multi-dimensional template with several shapes, infiltrating inside the template with metal oxides, followed by removing of nanotemplate, leading to multi-dimensional metal oxides. For example, AAO filter (anodized aluminum oxide with pores of a few hundred nanometer size) is used as a mold to infiltrate metal oxides inside the filter, followed by the removal of mold to fabricate multidimensional metal oxides. However, this method has difficulty in the application of high efficiency in hydrogen producing materials due to low surface area.

The above mentioned methods provide thin film metal oxides, instead of nanoparticle. To apply the methods, fabrication of multi-dimensional template should be easy, and nanotemplate with uniformity should be formed with reproducibility. However, the fabrication of multi-dimensional nanotemplate is complicated, thus it is difficult to fabricate nanostructure with uniformity on the large area more than an area of 1 inch×1 inch.

A conventional method for the synthesis of materials containing pores with 3D channel is reported in Korean published patent No. 10-2012-0032803A, involving the steps of formation of complex layers including nanomaterials and sacrificial particles using nanoparticle and sacrificial particles with larger particle size than nanoparticle, followed by removing sacrificial particle, thus leading to the ordered structure of 3D pores. However, this method has limitation in increasing the surface area.

Regarding with polymer materials having 3D channel shaped pores, a fabrication method of the polymer materials with high elasticity using proximity-field nanopatterning is reported in Nature Communications Volume 3, Article number 916. However, the fabrication method is limited to polymer with liquidity within template, which infiltrated into materials with 3D pores.

Therefore, fabrication methods of metal oxides having ordered multidimensional nanostructure with large surface area is currently developing to solve the aforementioned problems and to develop hydrogen-production material with high efficiency.

### SUMMARY OF THE INVENTION

The present invention provides a method for fabrication of metal oxide having 3D nanostructure, wherein said method is comprising the steps of: (a) spin-coating with photoresist onto substrate; (b) forming periodic 3D porous nanostructure patterned pore in said photoresist using proximity-field nanopatterning; (c) impregnating metal oxide into said 3D pore of photoresist having said periodic 3D pore pattern as template via atomic layered deposition (ALD) with metal precursor; and (d) obtaining 3D nanostructured porous metal oxide having the inverse shape of said template by removing said photoresist template.

In an exemplary embodiment, the size of pore and periodicity of 3D nanostructured metal oxide are controlled by controlling the wavelength of incident light and the periodicity and arrangement of phase mask used in the said proximity-field nanopatterning.

In an exemplary embodiment, the said metal precursor comprises at least one metal component selected from the group consisting of Ti, Al, Zn, Co, Ru and Ce.

In an exemplary embodiment, the said atomic layered deposition is performed at the temperature range of 50 to 200° C.

In an exemplary embodiment, the removal of the said photoresist template is done by thermal treatment or organic solvent treatment. In this case, the said thermal treatment is performed at the temperature of 400° C. to 1000° C. for 30 min to 24 hours. And the said organic solvent treatment involves at least one selected from the group consisting of ethanol, PGMEA, NMP, acetone, photoresist developer.

On the other hand, the present invention may have additional step of controlling surface oxygen defect concentration by applying dopant on the surface of said 3D nanostructure metal oxide after the removal of said photoresist template.

In this case, the said dopant is at least one selected from the group consisting of transition metal, nitrogen, halogen, oxygen, and sulfur.

The present invention also provides 3D nanostructure metal oxide fabricated according to the said method.

The Present invention provides hydrogen production material comprising said 3D nanostructured metal oxide.

The present invention also provide 3D porous nanostructured metal oxide, wherein said metal oxide has nano-size pores with regular or irregular shape along with each axis within the said metal oxide, wherein the said pores are interconnected with each other fully or partially forming channel.

In an exemplary embodiment, the size of the said nano-sized pore is within 50 to 2000 nm.

### BRIEF DESCRIPTION OF THE DRAWINGS

FIG. 1 is a flow diagram summarizing an exemplary method for fabrication of 3D nanostructured metal oxide.

FIG. 2 is a schematic diagram illustrating steps in an exemplary method for fabricating template with 3D pores via proximity-field nanopatterning.

FIG. 3 is a coarse diagram illustrating an ALD process of introducing metal oxide into 3D-porous template synthesized via proximity-field nanopatteming, followed by removal of said template.

FIG. 4 provides image of scanning electron microscope of 3D nanostructured photoresist template synthesized via proximity-field nanopatterning.

FIG. 5 provides images of scanning electron microscope of 3D nanostructured TiO2(a), aluminum oxide(b), zinc oxide(c), fabricated according to the exemplary embodiment of the present invention.

FIG. 6 provides XRD graph of 3D-titanium dioxide (TiO2) synthesized according to the exemplary embodiment of the present invention

### DETAILED DESCRIPTION OF THE PREFERRED EMBODIMENTS

The attached drawing illustrate the said metal oxide and the method of fabricating thereof. The present invention may apply various changes and different shape, therefore only illustrate in details with particular examples. However, the examples do not limit to certain shapes but apply to all the change and equivalent material and replacement. The drawings included are illustrated a fashion where the figures are expanded for the better understanding.

The technical or scientific terms used in the present invention has the same meaning as the skilled person in art comprehend in general, if otherwise defined in the present invention. If not apparent in the present invention, the terms should not be interpreted in the excessive scope.

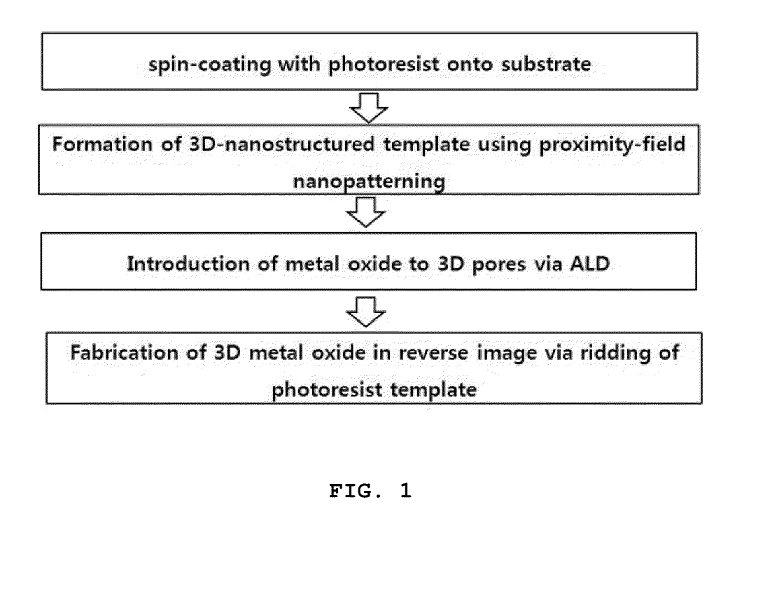

FIG. 1 is flow chart illustrating the method of fabricating 3D nanostructured metal oxide according to an exemplary embodiment of the present invention.

As shown from the said FIG. 1, the said method comprises the steps of: (a) spin-coating with photoresist onto substrate; (b) forming periodic 3D porous nanostructure patterned pore in said photoresist using proximity-field nanopatterning; (c) impregnating metal oxide into said 3D pore of photoresist having said periodic 3D pore pattern as template via atomic layered deposition (ALD) with metal precursor; and (d) obtaining 3D nanostructured porous metal oxide having the inverse shape of said template by removing said photoresist template.

The said pores with periodic 3D porous nanostructured pattern can be formed via applying proximity-field nanopatterning (PnP) to photoresist.

The said proximity-field nanopatterning (PnP) is a proper method of forming the said periodic 3D porous nanostructured pattern, and therefore, based on the composition mentioned below, 3D porous nanostructured pattern can be realized.

1) Light source such as substantially interference electromagnetic radiation, which has any wavelength that can create chemically and/or physically altered area on photoresist material.

2) Mask element, such as elastomer phase mask, when upon exposure to interference electromagnetic radiation (EMR), multiple beams of interference EMR is produced, affecting the optical interference of photoresist material, therefore creating optical interference pattern which has selected space distribution strength and polarized state.

3) Photoresist material, comprising light-initiated polymerized material by absorbing electromagnetic radiation from light-initiated polymer precursor, wherein said absorbing EMR leads to chemical etching or not, and leads to solvation by solvent or not.

The photoresist material in the said 3) may optionally comprise one or more light initiator which can bring changes in chemical and physical properties of photoresist material upon absorbing electromagnetic radiation.

The said proximity-field nanopatterning can realize 3D porous nanostructured pattern by conformal contact with at least one of contact surface between mask element and photoresist material, in particular atomic scale (less than 5 nm).

The said conformal contact may be provided by bringing at least a portion of the mask element (or a coating thereon) and photoresist material undergoing processing close enough together such that attractive intermolecular forces, such as Van der Waals forces, are established which bind the two elements. “Conformal contact” refers to contact established between surfaces and/or coated surfaces, which may be useful for establishing and maintaining optical alignment of a mask element and photoresist materials.

In one aspect, conformal contact involves that one or more contact surfaces of a mask elements, such as phase mask, contact to the overall shape of a surface of photoresist material, for example a flat, smooth, rough, contoured, convex or concave surface of photoresist material, macroscopically.

In another aspect, conformal contact involves that one or more contact surfaces of a mask element, such as a phase mask, contact to the overall shape of a surface of photoresist material, leading to an intimate contact without voids.

In one embodiment, mask elements of the presenting invention are capable of establishing conformal contact with one or more flat surfaces of photoresist material undergoing processing. Alternatively, mask elements of the presenting invention are also capable of establishing conformal contact with one or more contoured surface of photoresist material undergoing processing, such as a curved surface, convex surface, concave surface or surface having ridges, channels or other relief features thereon.

Conformal contact between at least a portion of the mask element and at least a portion the photoresist material provides an effective means of establishing and maintaining a selected optical alignment of these elements during processing for fabricating 3D structures having good pattern definition and resolution. Use of mask elements capable of establishing conformal contact with the surface of photoresist material is useful in the methods of the present invention because optical alignment with nanometer precision in the vertical direction (i.e. direction along an axis parallel to the propagation axis of the beam of electromagnetic radiation incident on the mask element.

The said desired periodic 3D porous nanostructure pattern of the present invention can be fabricated via selecting approximate physical dimensions and/or optical properties of said mask element capable of providing the desired 3D structure.

The method of fabricating periodic 3D porous nanostructure pattern according to the said Proximity-field nanopatterning techniques comprises steps of

1) providing a substantially interference beam of electromagnetic radiation,

2) directing said substantially interference beam of electromagnetic radiation onto a mask element forming conformal contact with photoresist material; wherein said mask element has at least one contact surface comprising a relief pattern in conformal contact with a contact surface of said photoresist material, wherein said relief pattern generates a plurality of beams of electromagnetic radiation, thereby generating an optical interference pattern within said photoresist material; wherein interactions of said electromagnetic radiation with said photoresist material generates chemically modified regions of said photoresist material, and

3) removing at least a portion of said chemically modified regions of said photoresist material or removing at least a portion of said photoresist material which is not chemically modified, thereby generating said 3D structure.

In this case, a contact between a phase mask comprising a polymeric material having a low modulus and high elasticity, such as an elastomer, and photoresist such as thin solid film of photo-polymer makes the said mask in touch with the surface of said polymer in atomic scale, via surface force similar to van der Vaal's type without the external force applied.

Light passing through the mask generates a 3D distribution of intensity that exposes the photoresist polymer throughout its thickness. Conceptually, this intensity distribution can be conceptualized of as being generated by the spatial overlap near the mask surface of beams produced by diffraction.

Removing the mask and developing away the parts of the photoresist polymer that are not cross-linked by the exposure light yields a 3D nanostructure in the geometry of the intensity distribution.

The geometry of phase mask defines the resulting 3D structures Important design factors include the 2D lattice constants, duty cycle (i.e. feature size, dc), relief depth (rd), and shape and size of the relief features.

The following documents provide more information on proximity-field nanopatterning method in details.
J. Phys. Chem. B 2007, 111, 12945-12958; Proc. Natl. Acad. Sci. U.S.A. 2004, 101, 12428; Adv. Mater. 2004, 16, 1369; KR 10-2006-0109477 A(2006.10.20).

In another aspect, 3D nanostructure of the present invention via PnP technology is capable of forming arbitrary shape of 2-D cross-section shape of said 3D nanostructure.

Using the said proximity-field nanopatterning method, the photoresist has 3D porous nanoscale structure pattern, with phase mask along with additional mask overlapped, and the shape of two dimensional cross section area of photoresist is corresponding to the shape of additional mask. Or photoresist undergoing the said proximity-field nanopatterning method is followed by additional patterning process to form a certain structure.

Photoresist materials usable in the methods of the present invention include any material which undergoes a chemical and/or physical change upon exposure to electromagnetic radiation. Photoresist materials of the present invention may be solids, liquids, or colloidal materials such as gels, sols, emulsions, and foams. Exemplary photoresist materials include, but are not limited to, materials which undergo photopolymerization upon absorption of electromagnetic radiation, such as photopolymerizable precursors. Photoresist materials also include, but are not limited to, materials that become susceptible or insusceptible to chemical etching upon absorption of electromagnetic radiation, or materials that become soluble or insoluble to chemical reagents, such as solvents, upon absorption of electromagnetic radiation.

For example, materials such as DNQ based positive tone photoresist, epoxy base negative tone photoresist, phenolic resin, organic-inorganic hybride material, hydrogel, etc. undergo photoreaction upon absorption of electromagnetic radiation, thus making them eligible candidates for photoresist material. Also, SU8, a negative photoresist, is another preferable photoresist material of the present invention.

Also, the thickness of photoresist layer used is 0.3 μm˜1 mm, preferably 1 μm˜100 μm, more preferably 5 μm˜30 μm.

The present invention provides the method of controlling the size of pore and periodicity of said 3D nanostructured metal oxide, by controlling the wavelength of incident light and the periodicity and arrangement of phase mask used in said proximity-field nanopatterning.

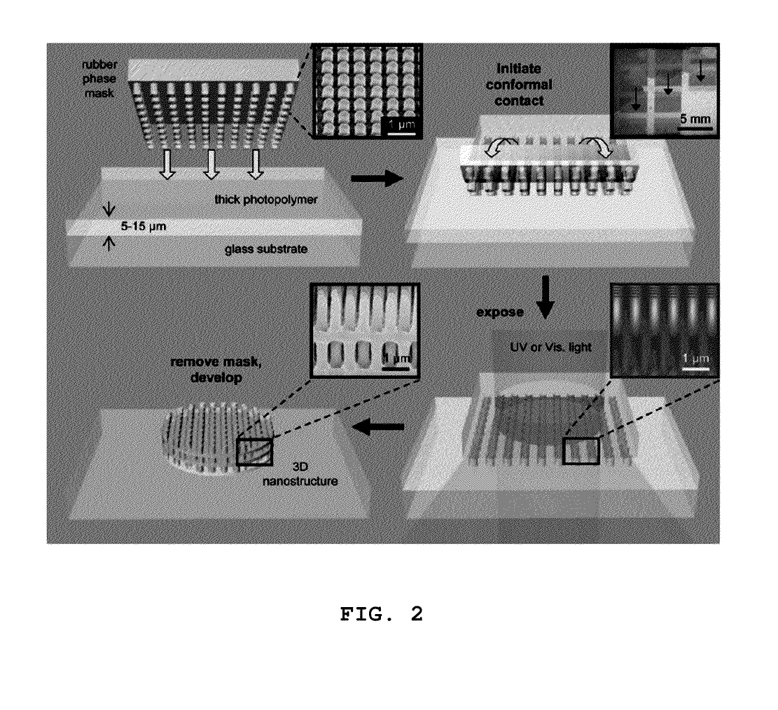

FIG. 2. illustrates the method of fabricating photoresist template with 3D porous via proximity-field nanopatterning method according to the embodiment of the present invention.

In more detail, according to FIG. 2, photoresist is coated with spin-coating onto substrate. If necessary, sacrificial layer can be used. The said sacrificial layer is polymer soluble in organic solvent, and normally photoresist treated thermal treatment above soft-baking temperature. For example, if using positive photoresist, such as DNQ based photoresist, hot plate is used above 110° C. for 5 minutes to form sacrificial layer.

The said substrate is a mean of creating photoresist layer. The kinds of said substrate have low reflection in UV wavelength region, preferably. To satisfy the condition of said substrate, there are glass substrate such as cover glass, and slide glass. If the substrate with high light reflectance is used, anti-reflection layer can be formed for bottom layer.

The said liquid photoresist is spin-coated, resulting in forming even thin layer; hot plate is used to soft bake the said layer for 5 mins at 100° C., forming a photoresist layer.

In one embodiment, in case of forming sacrificial layer, oxygen plasma treatment is applied to the glass substrate, followed by preliminary coating for the formation of 5 um positive-ton photoresist (AZ 9260, Clariant) on the substrate to form sacrificial layer. The said sacrificial layer is then hard-baked for 5 mins at 110° C., followed by spin-coating positive tone photoresist with 12 um of thickness on the said sacrificial layer at 2000 rpm for 30 secs.

Then, the said substrate coated with photoresist is soft baked for 5 min at 100° C. to get the desired photoresist-coated substrate.

The said photoresist can be selected from a group of light-initiated material such as DNQ-based positive-tone photoresist, organic-inorganic hybrid, hydrogel, phenolic resin, etc.

Next, porous polymer with periodic 3D porous nanostructure pattern is fabricated according to FIGS. 2b and 2d using PnP method. The phase mask used is PDMS, PUA, PFPE, PE and the structure of surface may have variable such as several periodicity, arrangement, and bump.

In one embodiment, for example, the phase mask comprises polydimethylsiloxane (PDMS) polyurethane acrylate (PUA), or perfluoropolyether (PFPE) and the mask can be fabricated cheaply via simple soft lithography casting and curing steps. In detail, 8 inch wafer coated with anti-reflection layer is under subject of spin-coating for photoresist, and expose and developing process to fabricate desired pattern, leading to formation of silicone master. Coating the silicon master by placing them in a perfluorinated trichlorosilane vapor prevents adhesion between the silicon master and the silicone elastomers during the casting and curing procedures

To fabricate elastomer phase mask corresponding to the said master, PDMS with bilayer structure can be used.

The casting begins by spin coating high modulus (˜10 MPa) type of poly dimethylsiloxane (PDMS) on the master, for example by spin coating at 1000 rpm for 30 seconds. Allowing PDMS on the master to continue to spin at 500 rpm for 30 minutes enables uniform partial crosslinking of the PDMS with high modulus. Extremely smooth surfaces can be obtained in this manner. Pouring a prepolymer to another low modulus (˜2 MPa) form of PDMS on top of the first layer generates soft backing for easy handling of the mask. Fully curing the bilayer PDMS element and peeling it away from the master yields a phase mask.

In an exemplary embodiment, according to FIG. 2b, phase masks with bump on the surface are in conformal contact, preferably atomic scale (<5 nm) conformal contact followed by the radiation in vertical direction from the top of the phase mask.

Afterward, it is flood exposed (20 to 450 mJ/cm2) and the constructive interference and destructive interference of incident light due the bump of phase mask form periodic 3D distribution within photoresist.

Next, according to FIG. 2d, in case of positive photoresist exposed photoresist is put to KOH solution-based developer, the exposed part is dissolved, where the unexposed part is left undissolved. Therefore, after drying in air, the photoresist with 3D porous nanostructure pattern can be obtained. In the case of usage of phase mask along with additional mask overlapped with each other, the shape of 2D cross sectional area pattern of photoresist lead to form a corresponding pattern of additional mask, or after using proximity-field nanaopatterning method, additional patterning process to form said photoresist in arbitrary shape will give the preferable form of photoresist with periodic 3D porous nanostructure pattern.

FIG. 2d illustrates the fabrication of photoresist template with 3D porous nanostructure pattern having circular cross section via additional patterning process or additional mask.

The present invention provides the periodic 3D porous nanostructure pattern within the said photoresist via proximity-field nanopatterning. The nano size pores within the photoresist can have periodic 3D porous nanostructure pattern with similar or same shape.

The term “periodic 3D porous nanostructure pattern” refers to the 3D network structure repeating with certain periodicity, according to the nanosize pores and materials having the 3D porous nanostructure, wherein said nanosize pores with the size of 1 to 2000 nm with regular or irregular shape along with each axis within the materials having the 3D porous nanostructure, wherein the said pores are interconnected with each other fully or partially forming channel.

In one embodiment, the present invention provides the methods of fabricating 3D porous nanostructure pattern metal oxide using photoresist with 3D porous nanostructure pattern as template, introducing metal oxide to the said pores via ALD, followed by the removal of photoresist template leading to the formation of metal oxide with 3D porous nanostructure pattern.

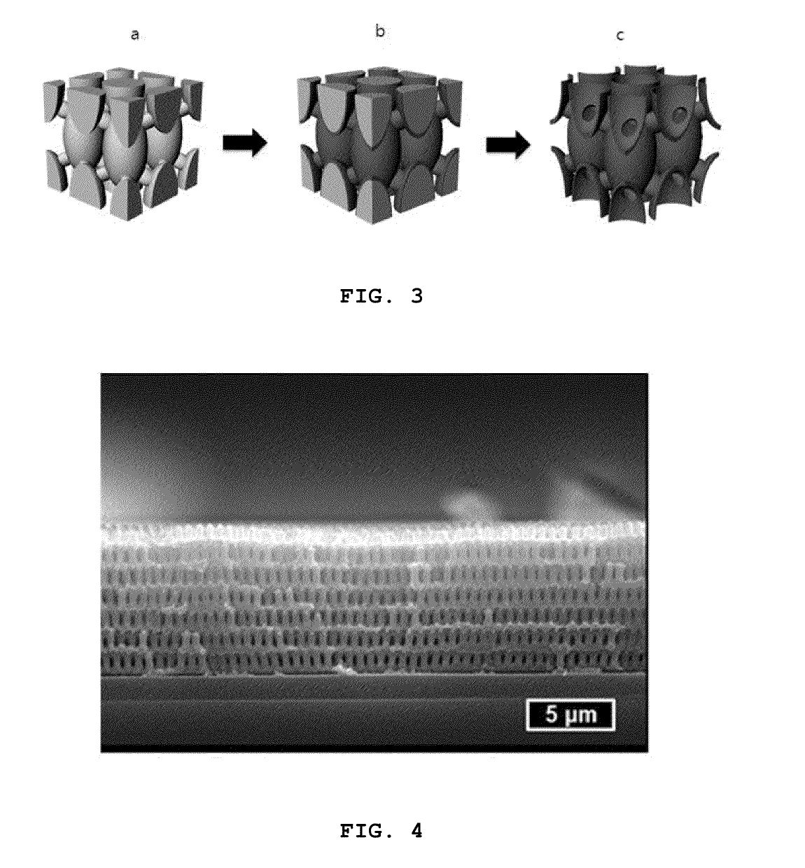

FIG. 3. is a drawing illustrating each steps of fabricating method of metal oxide, including introducing metal oxide with ALD to the template with 3D pores via proximity-field nanopatterning method.

Here, when the photoresist template with 3D pores via said proximity-field nanopatterning is fabricated, the metal oxide is deposited on the surface of pore within photoresist template to form layer of metal oxide via atomic layer deposition using metal precursor, making the said metal precursor introduced to the pores of photoresist.

Here, atomic layer deposition (ALD) has excellent deposition control ability, and the chemical reactive material in ALD is introduced in form of gas to the reactor, same as CVD. In case of CVD for the thin film deposition, all the chemicals necessary for the growth of the thin film is exposed to the surface, forming thin layer. On the contrary, the reactive materials for ALD, are introduced as pulse form, and in a fluid situation, each reactive material is separated from one another by purging gas. The pulse of each reactive material reacts with the surface chemically, forming precise thin film growth. ALD has self-limited reactive characteristic, allowing conformal process, leading to the precise film thickness control.

The said atomic layer deposition (ALD) can be categorized as thermal ALD utilizing the thermal reaction with water-vapor environment and PE-ALD utilizing the plasma degradation of oxygen.

The detailed description using the said atomic layer deposition using the first and second reactive gas to form thin film may have the following process.

First, the first reactive gas is applied to the top of a wafer ready inside the reactor. In this case, the said first reactive gas reacts with the top surface of the wafer and the chemical is adsorbed until no more reaction is occurred.

When the first react gas is fully reacting with the top surface of the wafer, the excess first reactive gas doesn't react with the surface anymore. The inert gas then, is removing the excess first reactive gas out of the reactor.

After removing the excess first reactive gas completely, the second reactive gas is applied to the top of the wafer, reacting with the surface of the top of the wafer, leading to the chemical adsorption. On the surface of wafer, the first and second reactive gas is chemically reacted with the surface, forming the atomic scale layers.

Then, when the second reactive gas is reacting the surface fully, the excess second reactive gas doesn't react with the surface anymore, and again the inert gas is used to rid of the excess second reactive gas out of the reactor.

The above sequence forms a cycle, and repeating of the said cycle gives the thin film with the desired atomic scale layer.

The said atomic layer deposition has advantage compared to chemical vapor deposition, such as lower temperature of formation of thin film, and easy and precise control of thickness down to a few A. Also the reactive gas is not applied to the inside the reactor chamber, simultaneously, preventing any contamination.

The precursor of metal oxide used in the said atomic layer deposition of the present invention comprises at least one selected from the group consisting of Ti, Al, Zn, Co, Ru, Ce.

When applying the metal precursor via atomic layer deposition, to the photoresist template with 3D pores via the said proximity-field nanopatterning, the metal oxide layer can be formed on the surface of the said template.

In this case, mild condition is necessary for atomic layer deposition to prevent the thermal destruction of 3D nanostructure of the said photoresist.

The said atomic layer deposition of this present invention is done at the temperature between 50 to 200° C., preferably 80 to 100° C.

FIG. 3b illustrates the deposition of the said metal oxide on photoresist templates with 3D pores.

The thickness of metal oxide deposited on the said photoresist template depends on the number of cycles of atomic layer deposition, with the preferable thickness is between 20 to 80 nm. Also, if ALD is repeated above certain number of cycle, the said 3D nanostructured pore can be filled with the metal oxide fully deposited.

The last step of fabricating 3D nanostructured porous metal oxide of the present invention is removing photoresist used as the said template, using either heat treatment or organic solvent.

The condition of removing template by the said heat treatment is that the temperature is between 400 to 1000° C. for 30 min to 24 hours.

The said heat treatment is done in air or under oxygen containing inert gas.

Also, in case of removing template by using the said organic solvent, kinds of organic solvent that can solvate photoresist is preferable without any limitation. The preferable solvent is selected any one from a group consisting of ethanol, PGMEA, NMP, acetone, photoresist developer.

FIG. 3c illustrates formation of pores in the inverse shape of the pores of said photoresist template around the metal oxide by removing the photoresist template, leaving the said metal oxide only.

In one embodiment, the 3D nanostructure metal oxide of the present invention can be doped with the dopant component to control the defect concentration of oxygen on the surface of metal oxide.

The said doping metal component is at least one selected from the group of transition metal, nitrogen, halogen, oxygen, and sulfur, etc., preferably nitrogen or halogen atom.

The method of doping the said dopant component comprises impregnating the said dopant component or precursor which combine with the metal component of metal oxide to metal oxide in water solution, or apply thermal treatment of metal oxide with said dopant component or precursor under inter gas at room temperature.

When transition metal is used as dopant, precursors comprising the said metal component can be organo transition metal complex.

For example, to dope platinum on the said 3D nanostructured metal oxide, chloroplatinate, one of precursors of platinum, is dissolved in the water, followed by dipping the said metal oxide in the solution and burning.

Also, in case of halogen or nitrogen, sulfur as dopant, the precursor gas for the dopant is filled with the chamber, following by heating process and the said 3D nanostructured metal oxide can be doped with the said dopant.

Also, the present invention provides metal oxide with 3D nanostructure fabricated by the said method. In more detail, the present invention relates to 3D porous nanostructured metal oxide, wherein said metal oxide has nano-size pores with regular or irregular shape along with each axis within the said metal oxide, wherein the said pores are interconnected with each other fully or partially forming channel.

Here, the metal component of the said metal oxide comprises at least one selected from the group consisting of Ti, Al, Zn, Co, Ru, preferably TiO2, zinc oxide, cerium oxide. Especially, cerium oxide is hydrogen-production material, which could realize high efficient hydrogen-production material possible with superior reactivity and reliability of said cerium oxide.

Also, the said metal oxide with 3D porous nanostructure has nano-sized pore with 50 to 2000 nm, and the whole thickness of metal oxide with the said 3D porous nanostructure is between 0.3 μm˜1 mm, preferably 1 μm˜100 μm.

The 3D metal oxide fabricated according to the present invention is in the shape of thin shell, with the thickness of shell within the metal oxide is 20 to 80 nm depending on the number of cycle of atomic layered deposition. And the final thickness of 3D metal oxide depends on photoresist as 3D nanotemplate, being 0.3 μm˜1 mm, preferably 1 μm˜100 μM.

Also, the metal oxide having said 3D porous nanostructure may have at least one or more dopant such as transition metal, nitrogen, halogen, oxygen, sulfur etc., on the surface of nanostructure metal oxide to control oxygen defect concentration.

If the said dopant is transition metal, platinum, zinc, aluminum, etc. is preferred, whereas if the sad dopant is halogen, iodine, fluoride, and bromine is preferred.

The present invention provides efficient hydrogen-producing metal oxide by controlling oxygen defect concentration via doping 3D nanostructured metal oxide with large surface area.

The experiment will give details of the present invention. This is just a representative example, not limiting the scope of this invention.

### EXAMPLES

### Example 1

### Fabrication of 3-D Nanostructured Titanium Dioxide

### Example 1-1

### Formation of Photoresist Layer and Photoresist Template Bearing 3D Pores Via Proximity-Field Nanopatterning

SU8 photoresist comprising monomer represented as formula A below is coated on glass substrate via spin-coating at 2000 rpm, followed by heating the said substrate on the hot plate with temperature of 95° C. for 10 minutes, applying photoresist layer on the said substrate. Applied photoresist layer has thickness of 10˜15 μm.

Formula A

Using laser having wavelength of 355 nm, porous 3D template is fabricated via PnP using phase mask consisting of PDMS with periodic corrugated shape.

The 3D nanostructure template via proximity-field nanopatterning is described in FIG. 4.

### Example 1-2

### Formation of Metal Oxide Using 3D Porous Nanostructured Photoresist as Template Via Atomic Layered Deposition, Followed by Thermal Treatment

Tetrakis dimethylamido titanium, used as Titanium oxide precursor, is applied to ALD process at 80° C. under pressure of 10-3 Ton inside the chamber. To form said Titanium oxide, 700 cycles of ALD are performed and the thickness of TiO2 layer is 56 nm To remove photoresist template via thermal treatment, the plate is heated at 500° C. for 2 hours under air atmosphere.

### Example 1-3

### Nitrogen Doping Step

Additional dopant, nitrogen in this case, is applied to 3D nanostructured porous metal oxide by thermal treatment at 400° C. under nitrogen atmosphere.

### Examples 2 and 3

### Fabrication of 3D Nanostructured Zinc Oxide and Aluminum Oxide

Trimethylaluminium (Example 2) as aluminum's precursor and Diethylzinc (Example 3) as zinc's precursor is used in place of Tetrakis dimethylamido titanium from Example 1 to fabricate 3-D porous nanostructured aluminum oxide (Example 2) and zinc oxide (Example 3).

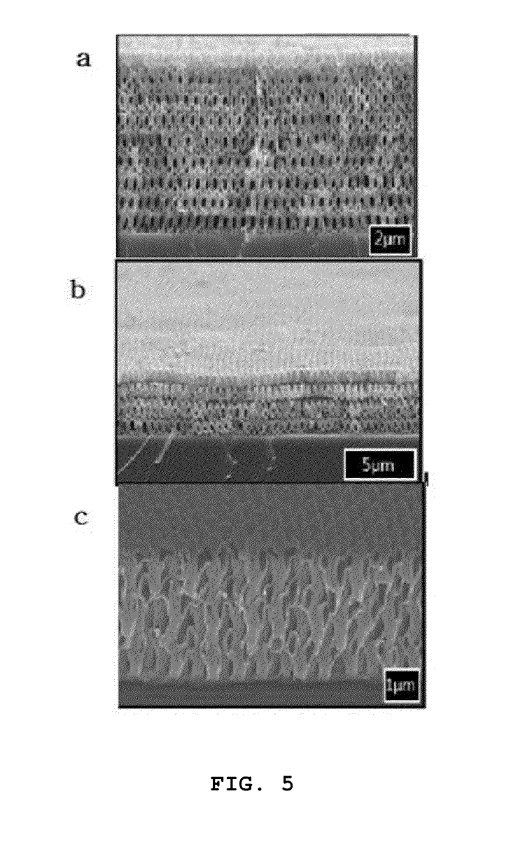

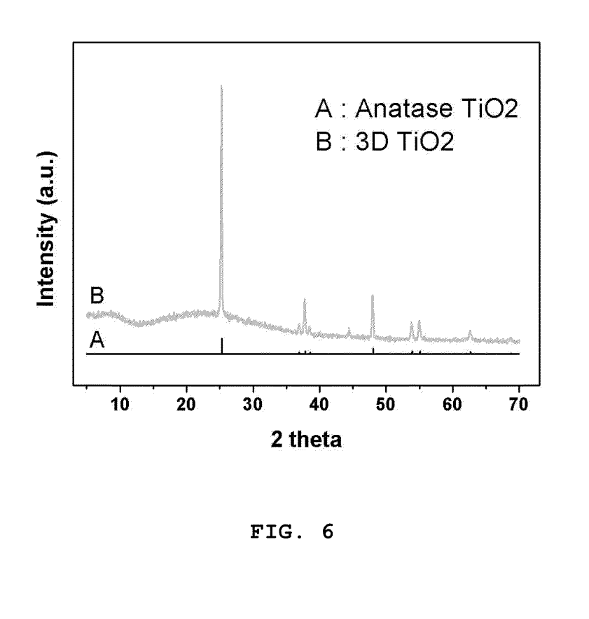

The synthesized 3D nanostructured metal oxides according to Example 1 thru 3 are described in FIG. 5. In particular, the FIG. 5a to FIG. 5c represent the side cross-sectional diagram of TiO2(FIG. 5a), Al2O3(FIG. 5b), and ZnO (FIG. 5c), prepared from EXAMPLE 1, EXAMPLE 2 and EXAMPLE 3 of the present invention, respectively, demonstrating formation of periodical 3-D porous nanostructured metal oxide.

FIG. 6 is a graph illustrating XRD result of metal oxide (TiO2) synthesized by the methods in examples of the present invention.

As shown from XRD result of the said FIG. 6, the peaks at 25.28°, 36.94°, 48.05° are observed in case of 3D-TiO2, and the said 3D-TiO2 is anatase phase.

It will be apparent to one of ordinary skill in the art that methods, materials, procedures and techniques other than those specifically described herein, can be applied to the practice of the invention as broadly disclosed herein without resort to undue experimentation. All art-known functional equivalents of methods, materials, procedures and techniques specifically described herein are intended to be encompassed by this invention.

What is claimed is:

1. A method for fabrication of metal oxide having 3D nanostructure, wherein said method is comprising the steps of:
(a) spin-coating photoresist onto substrate;
(b) forming periodic 3D porous nanostructure patterned pore in said photoresist using proximity-field nanopatterning;
(c) impregnating metal oxide into said 3D pore of photoresist having said periodic 3D pore pattern as template via atomic layered deposition (ALD) with metal precursor; and
(d) obtaining 3D nanostructured porous metal oxide having the inverse shape of said template by removing said photoresist template.

2. The method of claim 1, wherein the size of pore and periodicity of said 3D nanostructured metal oxide are controlled by controlling the wavelength of incident light and the periodicity and arrangement of phase mask used in said proximity-field nanopatterning.

3. The method of claim 1, wherein said metal precursor comprises at least one metal component selected from the group consisting of Ti, Al, Zn, Co, Ru and Ce.

4. The method of claim 1, wherein said atomic layered deposition (ALD) is performed at the temperature of 50 to 200° C.

5. The method of claim 1, wherein the removal of said photoresist template is done by thermal treatment or organic solvent treatment.

6. The method of claim 5, wherein the temperature of said thermal treatment is between 400° C. to 1000° C. for 30 min to 24 hours.

7. The method of claim 5, wherein said organic solvent is at least one selected from the group consisting of ethanol, PGMEA, NMP, acetone, photoresist developer.

8. The method of claim 1, wherein the removal of said photoresist template is followed by additional step of controlling surface oxygen defect concentration by applying dopant on the surface of said 3D nanostructure metal oxide after the removal of said photoresist template.

9. The method of claim 8, wherein said dopant is at least one selected from the group consisting of transition metal, nitrogen, halogen, oxygen, and sulfur.

10. 3D nanostructure metal oxide fabricated according to the method of claim 1.

11. Hydrogen-production material comprising said metal oxide of claim 10.

12. 3D porous nanostructured metal oxide, wherein said metal oxide has nano-size pores with regular or irregular shape along with each axis within the said metal oxide, wherein the said pores are interconnected with each other fully or partially forming channel.

13. 3D porous nanostructured metal oxide of claim 12, wherein metal component of said metal oxide comprises at least one selected from the group consisting of Ti, Al, Zn, Co, Ru and Ce.

14. 3D porous nanostructured metal oxide of claim 12, wherein the size of said nano-sized pore is within 50 to 2000 nm.

15. 3D porous nanostructured metal oxide of claim 12, wherein dopant is additionally added to the surface of 3D nanostructured metal oxide to control the oxygen defect concentration of the said surface.

16. 3D porous nanostructured metal oxide of claim 15, wherein the dopant is at least one selected from the group consisting of transition metal, nitrogen, halogen, oxygen, and sulfur.

17. Hydrogen-production material comprising said 3D porous nanostructured metal oxide of claim 12.
